(19) United States
(12) Patent Application Publication
(10) Pub. No.: US 2014/0279067 A1
(43) Pub. Date: Sep. 18, 2014

(54) PROTECTED DATA SHARING BETWEEN ADVERTISERS AND PUBLISHERS

(71) Applicant: MICROSOFT CORPORATION, REDMOND, WA (US)

(72) Inventor: JIA LEI, BEIJING (CN)

(73) Assignee: MICROSOFT CORPORATION, REDMOND, WA (US)

(21) Appl. No.: 13/803,087

(22) Filed: Mar. 14, 2013

(51) Int. Cl. G06Q 30/02

(52) U.S. Cl. CPC G06Q 30/0277
USPC 705/14.73

(57) ABSTRACT

Methods, computer systems, and computer-storage media are provided for facilitating the exchange of meaningful information between an advertiser and an advertisement publisher in a protected manner using common identifiers (IDs). A third-party agency service receives user advertiser IDs from the advertiser and user publisher IDs from the advertisement publisher and, for each user, maps a user's advertiser ID to its corresponding publisher ID. The third-party agency service assigns a common ID to each mapped pair and communicates the common IDs to the advertiser and the advertisement publisher. Using the common IDs, the advertiser is able to directly request online behavior data for different consumer buying segments from the advertisement publisher. In turn, the advertisement publisher utilizes the common IDs to directly communicate the request results back to the advertiser.

### BACKGROUND

User privacy concerns are important to not only online advertisers but to the advertisement publishers that display the advertisements. For example, advertisers (e.g., companies that sell or promote products and/or services) have in their possession protected user information involving such things as amounts of online purchases, consumer buying segments, identities of users, frequency of purchases, types of products or services purchased, spending shifts associated with different products and/or services, and the like. As well, advertisement publishers such as Bing® have in their possession protected sources of online behavior data for authenticated users.

There have been some attempts to promote data sharing between advertisers and advertisement publishers. For instance, there are intermediary third-party agencies that map user advertiser identifiers (IDs) provided by advertisers with user publisher IDs provided by advertisement publishers in order to anonymously transmit information regarding a specified advertising campaign between the advertiser and the advertisement publisher. Advertisers can then issue requests to the third-party agency for user engagement data related to one or more users identified by their advertiser IDs. The third-party agency determines publisher IDs corresponding to the advertiser IDs and requests from the advertisement publisher engagement data for the users. This information is provided to the third-party agency by the advertisement publisher but is typically limited to general metrics such as number of impressions, number of clicks, and a yes/no determination of whether a particular user engaged in the specified advertising campaign. The limitation of information to general metrics is based in part on the high computational cost associated with measuring each individual user's online behavior. As well, the limitation is based on legal restrictions that prohibit advertisers from having full access to an individual user's online and offline behavior; such restrictions prevent advertiser from over-advertising with respect to individual users.

As seen, conventional approaches to data sharing between advertisers and advertisement publishers limit direct interactions between these two parties. Instead, the advertiser ends up paying the third-party agency for data that has limited utility. Further, because the third-party agency typically limits advertiser requests to information regarding a specified advertising campaign, advertisers are unable to obtain a comprehensive view of user behavior across multiple campaigns.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, creating a trustworthy environment in which valuable information can be shared directly between advertisers and advertisement publishers. As mentioned, concerns over user privacy currently prevent advertisers and advertisement publishers from fully sharing sensitive user information. However, sharing portions of this data in an anonymous and protected manner would benefit both parties. For example, providing advertisers with comprehensive online behavior data for different consumer buying segments would help the advertisers understand what is driving, or not driving, purchasing behavior for these segments. As well, by providing online behavior data in a protected manner to advertisers, advertisement publishers would provide a much needed value-added service that would ultimately help to increase advertiser engagement with the advertisement publisher.

As used throughout this application, the term “online behavior data” refers to a broad range of online user behavior such as, for example, Web sites visited, search queries used, times spent at different Web sites, user selections, user hovers, uniform resource locator (URL) streams, frequency of interaction with particular Web sites, active viewing times, and the like. Advertisement publishers may anonymously aggregate this data across a spectrum of users. As well, the online behavior data for a particular user may be tracked by an advertisement publisher upon the user logging in and being authenticated. Users who have been authenticated by the advertisement publisher are typically assigned a publisher identifier (ID).

Thus, the current invention provides for a third-party agency service that receives user data and associated advertising identifiers (IDs) from an advertiser and user data and associated publisher IDs from an advertisement publisher. This information is not limited to a particular advertising campaign but, instead, represents the whole user pool associated with the advertiser and the advertisement publisher. For each user, the user's advertising ID is matched to the user's publisher ID, and a common ID is assigned. In turn, the user's common ID is communicated to both the advertiser and the advertisement publisher. The use of a common ID ensures anonymity to both the advertiser and the advertisement publisher.

In order to determine the effectiveness of its online advertising programs, the advertiser may wish to view online behavior data for, for example, one or more specified consumer buying segments, or to analyze the difference in online behavior data between a specified consumer buying segment and another segment. Accordingly, the advertiser directly communicates a request to the advertisement publisher and identifies each user in these segments by the user's common ID. Upon receiving the request, the advertisement publisher identifies a publisher ID associated with each of the common IDs and accesses rich online behavior data for this group using the publisher IDs. The advertisement publisher analyzes the online behavior data and communicates the analyzed data to the advertiser using the each user's common ID. As can be seen, the use of a common ID prevents both the advertiser and the advertisement publisher from accessing sensitive user information but still allows the exchange of meaningful data.

Accordingly, in one embodiment, the present invention is directed to one or more computer-storage media having computer-executable instruction embodied thereon that, when executed by one or more computing devices, perform a method of facilitating the exchange of information between an advertiser and an advertisement publisher in a protected manner using common IDs. The method comprises, at a third-party agency service, receiving one or more sets of user data from an advertiser; each set of the one or more sets of user data is associated with a user having an advertising ID. As well, one or more sets of user data are received from an advertisement publisher, where each set of the one or more sets of user data is associated with a user having a publisher ID. At least one advertising ID is mapped to at least one publisher ID. The at least one advertising ID and the at least one publisher ID are associated with a first user. The first user is assigned a common ID, and the common ID is communicated to the advertiser and the advertisement publisher.

In another embodiment, the presented invention is directed to a computerized method carried out by an advertisement publisher service having at least one processor for facilitating the exchange of information between an advertiser and the advertisement publisher in an anonymous manner. The method comprises receiving a request from the advertiser for online behavior data associated with a first set of users. Each user in the first set of users is identified only by the each user's respective common identifier (ID). For the each user in the first set of users, a publisher ID associated with the each user's respective common ID is identified, and the publisher IDs are used to access online behavior data for the first set of users. Using the at least one processor, the online behavior data is analyzed for the first set of users. The analyzed online behavior data for the first set of users is communicated to the advertiser using only the each user's respective common ID.

In yet another embodiment, the present invention is directed to a computer system for facilitating the anonymous exchange of information between an advertiser and an advertisement publisher. The system comprises a computing device associated with a third-party agency service having one or more processors and one or more computer-storage media and a data store coupled with the third-party agency service. The third-party agency service receives sets of user data from the advertiser; each set of user data is associated with a user having an advertising ID. The third-party agency service also receives sets of user data from the advertisement publisher; each set of user data is associated with a user having a publisher ID. The third-party agency service maps each advertising ID to its corresponding publisher ID using the sets of data received from the advertiser and the advertisement publisher. Each advertising ID and its corresponding publisher ID are associated with a same user. A common ID is assigned to each mapped pair, and the common ID is communicated to the advertiser and the advertisement publisher.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for facilitating the anonymous exchange of meaningful information between an advertiser and an advertisement publisher using common identifiers (IDs) suitable for use in implementing embodiments of the present invention;

FIG. 3 is a process-flow diagram of an exemplary process for facilitating the anonymous exchange of meaningful information between an advertiser and an advertisement publisher using common IDs in accordance with an embodiment of the present invention;

FIG. 4 is a flow diagram of an exemplary method of utilizing a third-party agency service to assign to a user a common ID that links the user's advertiser ID and the user's publisher ID in accordance with an embodiment of the present invention; and

FIG. 5 is a flow diagram of an exemplary method of using common IDs to facilitate the anonymous exchange of meaningful information between an advertiser and an advertisement publisher in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-storage media for, among other things, creating a trustworthy environment in which valuable information can be shared between advertisers and advertisement publishers. As mentioned, user privacy concerns currently prevent advertisers and advertisement publishers from fully sharing sensitive user information. However, sharing portions of this data in an anonymous and protected manner would benefit both parties. For example, providing advertisers with online behavior data for different consumer buying segments would help the advertisers understand what is driving, or not driving, purchasing behavior. As well, by providing online behavior data in a protected manner to advertisers, advertisement publishers would provide a much needed value-added service.

Thus, the current invention provides for a third-party agency that receives user data and associated advertising identifiers (IDs) from an advertiser and user data and associated publisher IDs from an advertisement publisher. For each user, the user's advertising ID is matched to the user's publisher ID, and a common ID is assigned. In turn, the user's common ID is communicated to both the advertiser and the advertisement publisher.

In order to determine the effectiveness of its online advertising programs, the advertiser may wish to view online behavior data for, for example, one or more specified consumer buying segments, or to analyze the difference in online behavior data between a specified consumer buying segment and another segment. Accordingly, the advertiser directly communicates a request to the advertisement publisher and identifies each user in these segments by the user's common ID. Upon receiving the request, the advertisement publisher identifies a publisher ID associated with each of the common IDs and accesses rich online behavior data for this group using the publisher IDs. The advertisement publisher analyzes the online behavior data and communicates the analyzed data to the advertiser using the each user's common ID. As can be seen, the use of a common ID prevents both the advertiser and the advertisement publisher from accessing sensitive user information but still allows the exchange of meaningful data.

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant, a smart phone, a tablet PC, or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

Furthermore, although the term “server” is often used herein, it will be recognized that this term may also encompass a search engine, an advertisement publisher service, a third-party agency service, an advertiser service, a Web browser, a cloud server, a set of one or more processes distributed on one or more computers, one or more stand-alone storage devices, a set of one or more other computing or storage devices, a combination of one or more of the above, and the like.

Referring now to FIG. 2, a block diagram is provided illustrating an exemplary computing system 200 in which embodiments of the present invention may be employed. Generally, the computing system 200 illustrates an environment where advertisers, advertisement publishers, and third-party agencies work together to facilitate the exchange of meaningful information between the advertisers and the advertisement publishers in a trustworthy manner using common IDs.

Among other components not shown, the computing system 200 generally includes a third-party agency service 210 and its associated data store 212, an advertiser service 220 and its associated data store 222, and an advertisement publisher service 226 and its associated data store 228 all in communication with one another via a network 234. The third-party agency service 210 may be associated with a third-party agency, the advertiser service 220 may be associated with an advertiser, and the advertisement publisher service 226 may be associated with an advertisement publisher. The network 234 may include, without limitation, one or more local area networks (LANs) and/or wide area networks (WANs). Such networking environments are commonplace in offices, enterprise-wide computer networks, intranets and the Internet. Accordingly, the network 234 is not further described herein.

It should be understand that any number of third-party agency services, advertiser services, and advertisement publisher services may be employed in the computing system 200 within the scope of embodiments of the present invention. Each may comprise a single device/interface or multiple devices/interfaces cooperating in a distributed environment. For instance, the third-party agency service 210 may comprise multiple devices and/or modules arranged in a distributed environment that collectively provide the functionality of the third-party agency service 210 described herein. Additionally, other components/modules not shown also may be included within the computing system 200.

In some embodiments, one or more of the illustrated components/modules depicted in association with the third-party agency service 210, the advertiser service 220, and/or the advertisement publisher service 226 may be implemented as stand-alone applications. In other embodiments, one or more of the illustrated components/modules may be implemented as an Internet-based service, as a third-party application service, or as a module inside the third-party agency service 210, the advertiser service 220 and/or the advertisement publisher service 226. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the third-party agency service 210 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The third-party agency service 210 may be associated with a third-party agency that acts as a trusted intermediary between advertisers and advertisement publishers. As explained in greater depth below, the third-party agency service 210 receives confidential user information from advertisers and advertisement publishers, matches the information by user, assigns a common identifier (ID) to each user, and communicates the common ID to the advertiser and the advertisement publisher. All of this is accomplished while maintaining the confidentiality of the user information.

As illustrated, the third-party agency service 210 includes a receiving component 214, a mapping component 216, and a communication component 218. In some embodiments, one or more of the components 214, 216, and 218 may be implemented as stand-alone applications. In other embodiments, one or more of the components 214, 216, and 218 may be integrated directly into the operating system of a computing device such as the computing device 100 of FIG. 1. It will be understood that the components 214, 216, and 218 illustrated in FIG. 2 are exemplary in nature and in number and should not be construed as limiting. Any number of components may be employed to achieve the desired functionality within the scope of embodiments hereof.

The illustrated third-party agency service 210 also has access to its data store 212. The information stored in association with the data store 212 is configured to be searchable for one or more items of information stored in association therewith. The information stored in association with the data store 212 may comprise general information used by the third-party agency service 210. For example, the data store 212 may store information received from advertisers such as user information concerning customers along with advertising IDs assigned to the customers by the advertiser. As well, the data store 212 may store user information received from advertisement publishers concerning online users along with publisher IDs assigned to the online users by the advertisement publishers. User information in both of these cases may refer to identifying information such as, for example, first and last name, date-of-birth, gender, address, and the like. The data store 212 may also store for each user a mapping between the user's advertiser ID, publisher ID, and common ID.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the third-party agency service 210.

The receiving component 214 of the third-party agency service 210 is configured to receive user information and associated advertiser IDs from the advertiser service 220 via, for example, the internet 234. As well, the receiving component 214 is configured to receive user information and associated publisher IDs from the advertisement publisher service 226. The user information in both of these cases generally represents the entire user pool associated with each of the advertising service 220 and the advertisement publisher service 226. In other words, the user information is not restricted or limited to users associated with a particular advertising campaign.

The mapping component 216 of the third-party agency service 210 is configured to utilize the user information received from the advertiser service 220 and the advertisement publisher service 226 to map each user's advertising ID to its corresponding publisher ID utilizing matching algorithms known in the art. For example, user information associated with publisher ID “xxx1” may indicate that the user's name is John Smith. Similarly, user information associated with advertiser ID “yyy1” may indicate that the user's name is John Smith. Additional information such as date-of-birth, street address, and/or gender may be used to arrive at a best guess match that the advertiser ID “yyy1” should be mapped to the publisher ID “xxx1.” The mapping may subsequently be stored in the data store 212.

The mapping component 216 is further configured to assign each mapped advertiser ID/publisher ID pair a common ID. Using the example above for user John Smith, a common ID “zzz1” may be assigned to the mapped pair xxx1/yyy1. The mapping between the advertiser ID, the publisher ID, and the common ID may also be stored in association with the data store 212.

The communication component 218 of the third-party agency service 210 is configured to communicate each user's common ID to both the advertiser service 220 and the advertisement publisher service 226. A user's common ID may be communicated to the advertiser service 220 in association with the user's advertiser ID. Likewise, the user's common ID may be communicated to the advertisement publisher service 226 in association with the user's publisher ID.

Turning now to the advertiser service 220, the advertiser service 220 may be associated with an advertiser. As used throughout this application, an advertiser may be defined as a company, entity, and/or individual that sells or promotes goods and/or services using online advertising. As such, the advertiser (or a third-party company working in collaboration with the advertiser) may develop online marketing campaigns for specified products or services, consumer buying segments, times, and the like. Although only one advertiser service is illustrated in FIG. 2, it is contemplated that the computer system 200 may encompass any number of advertisement publishers.

As illustrated, the advertiser service 220 includes the associated data store 222 and a communication component 224. In some embodiments, the communication component 224 may be implemented as a stand-alone application. In other embodiments, the communication component 224 may be integrated directly into the operating system of a computing device such as the computing device 100 of FIG. 1. It will be understood that the component 224 illustrated in FIG. 2 is exemplary in nature and in number and should not be construed as limiting. Any number of components may be employed to achieve the desired functionality within the scope of embodiments hereof.

The communication component 224 of the advertiser service 220 is configured to communicate with the third-party agency service 210 and the advertisement publisher 226. For instance, the communication component 224 is configured to communicate user information and associated advertiser IDs to the third-party agency service 210. The communication component 224 is further configured to receive user common IDs from the third-party agency service 210 and store this information in association with the data store 222. As well, the communication component 224 is configured to directly communicate requests for online behavior data to the advertisement publisher 226. The requests may be for online behavior data related to a particular consumer buying segment. As used throughout this application, the term “consumer buying segment” refers to a group of users who have interacted with the advertiser in some manner. The interaction may include such things as purchasing a product and/or service from the advertiser, registering with the advertiser, placing a product and/or service in a virtual shopping cart, and the like. Each user in the consumer buying segment is identified solely by his or her respective common ID. Thus, no user identifying information is communicated with the request. The request may additionally be for a comparison of online behavior data for different consumer buying segments. By way of example, the advertiser may wish to know differences in online behavior for consumer buying segments that typically spend over a $100 and consumer buying segments that typically spend less than $100.

The communication component 224 of the advertiser service 220 is also configured to receive online behavior data for the consumer buying segment(s) directly from the advertisement publisher service 226. The online behavior data is received solely in association with the users' common IDs. The communication component 224 subsequently maps the received common IDs to their respective advertiser IDs to identify the users associated with the online behavior data and may store this information in association with the data store 222.

The data store 222 associated with the advertiser service 220 is configured to store information for use by the advertiser service 220. As such, the information stored in association with the data store 222 is configured to be searchable for one or more items of information stored in association therewith. The data store 222 may store information concerning users such as user identifying information, advertisers IDs assigned by the advertiser service 220 to each user, user account information, frequency of purchases, registered payment instruments, user online engagement history, types of purchases, and the like. The data store 222 may also store a mapping of advertiser IDs and common IDs for users.

The content and volume of such information in the data store 222 are not intended to limit the scope of embodiments of the present invention in any way. Further, though illustrated as a single, independent component, the data store 222 may, in fact, be a plurality of storage devices, for instance, a database cluster, portions of which may reside on the advertising service 220.

The advertisement publisher service 226 may be associated with an advertisement publisher. As used throughout this application, the term advertisement publisher includes any service and/or company that publishes or delivers advertisements either via the Web or in print. Such companies are numerous but representative examples may include public search engines such as, for example, Bing®, paid search services, social network sites such as Facebook® or Twitter®, social news sites such as Reddit®, social photo and video sharing sites such as YouTube®, social bookmarking sites such as Pinterest® and other third-party application sites, blogs, email marketing companies, and the like. Although only one advertisement publisher service is illustrated in FIG. 2, it is contemplated that the computer system 200 may encompass any number of advertisement publisher services.

As illustrated, the advertisement publisher service 226 includes the associated data store 228, a communication component 230, and an analyzing component 232. In some embodiments, the communication component 230 and the analyzing component 232 may be implemented as stand-alone applications. In other embodiments, the components 230 and 232 may be integrated directly into the operating system of a computing device such as the computing device 100 of FIG. 1. It will be understood that the components 230 and 232 illustrated in FIG. 2 are exemplary in nature and in number and should not be construed as limiting. Any number of components may be employed to achieve the desired functionality within the scope of embodiments hereof.

The communication component 230 of the advertisement publisher service 226 is configured to communicate with the third-party agency service 210 and the advertiser service 220. For instance, the communication component 230 is configured to communicate user information and associated publisher IDs to the third-party agency service 210. The communication component 230 is further configured to receive user common IDs from the third-party agency service 210 and store this information in association with the data store 228. As well, the communication component 230 is configured to directly receive requests for online behavior data from the advertiser service 220. The requests may be for online behavior data related to a particular consumer buying segment(s); each user in the segment is identified solely by his or her respective common ID. Additionally, the request may be for a comparison of online behavior data for different consumer buying segments. In response to the received request, the communication component 230 is further configured to communicate the results of the request directly to the advertiser service 220 using only the common IDs. The communication component 230 may also communicate action suggestions based on the result data directly to the advertiser service 220 as explained in greater depth below.

The analyzing component 232 is configured to map the common IDs received with the request from the advertiser service 220 to corresponding publisher IDs for each user. Using the publisher IDs for the consumer buying segment, the analyzing component 232 accesses online behavior data from, for example, the data store 228. The analyzing component 226 is further configured to perform various analytics on the online behavior data in order to provide a more comprehensive picture of online behavior for the segment. For example, the analyzing component 226 may determine top sites visited, active visiting times, engagement actions based on demographic differences within and between segments, and identified user interests associated with the consumer buying segment. As well, the analyzing component 226 may analyze differences between online behavior data for two or more different consumer buying segments such as differences in advertisement engagement based on demographics, a comparison of top sites visited, a comparison of active viewing times, a comparison of identified user interests, and the like.

Additional analytics performed by the analyzing component 232 may include times and frequency of advertising exposure from the advertiser in question or a competitor advertiser. This may be subdivided based on size of advertisement, rich or plain implementation of the advertisement, location of the advertisement, and the like. Analytics may further include user engagement with respect to a content category (e.g., a content category may include automobiles which consist of Web sites publishing automobile-type content). Engagement with respect to a content category may reflect users' long-term interests. Analytics may also include user intent expressed via search queries and selected search results. For example, an advertiser may be promoting a particular product, and a well-known review site subsequently publishes a negative review of the product. Due to its high relevance, the review article may be listed on the first results page when a user enters a search query for the product. It is useful to see differences between users who read the review article versus those who do not so as to evaluate the impact of the review on sales of the product.

The analyzing component 232 is further configured to determine one or more action suggestions based on the analyzed data. The action suggestions are suggestions provided to the advertiser to help increase user engagement with online advertisements.

As described above, the illustrated advertisement publisher service 226 has access to the data store 228. The data store 228 is configured to store information for use by, for example, the advertisement publishing service 226. The information stored in association with the data store 228 is configured to be searchable for one or more items of information stored in association therewith. For example, the data store 228 may store user identifying information, publisher IDs assigned to authenticated users by the advertisement publisher service 226, mappings of publisher IDs to common IDs, online behavior data, cached online content, cached advertisement files, and the like.

The content and volume of such information in the data store 228 are not intended to limit the scope of embodiments of the present invention in any way. Further, though illustrated as a single, independent component, the data store 228 may, in fact, be a plurality of storage devices, for instance, a database cluster, portions of which may reside on the advertisement publisher service 226.

Turning now to FIG. 3, a process-flow diagram, referenced generally by the numeral 300, is depicted illustrating a method of facilitating the exchange of information between an advertiser and an advertisement publisher using common IDs. FIG. 3 includes an advertiser service 310, an advertisement publisher service 312, and a third-party agency service 314. The advertiser service 310 may be the same as the advertising service 220 of FIG. 2. Similarly, the advertisement publisher service 312 may be the same as the advertisement publisher service 226 of FIG. 2, and the third-party agency service 314 may be the same as the third-party agency service 210 of FIG. 2

At a step 316, the advertiser service 310 communicates user information and associated advertiser IDs 318 to the third-party agency service 314. The user information 318 may include identifying information such as name, address, date-of-birth, gender, and the like. Besides having identifying information, each user also has an advertiser ID assigned by the advertising service 310. The user information and associated advertiser IDs 318 represent the pool of users associated with the advertiser service 310 and is not limited to users associated with a particular advertising campaign.

At a step 320, the advertisement publisher service 312 communicates user information and associated publisher IDs 322 to the third-party agency service 314. The user information 322 also includes user identifying information such as name, address, date-of-birth, gender, and the like. Each authenticated user has an associated publisher ID assigned to the user by the advertisement publisher service 312. Like above, the user information and associated publisher IDs 322 represent the user pool associated with the advertisement publisher service 312.

At a step 324, the third-party agency service 314 utilizes the user information received from the advertising service 310 and the advertisement publisher service 312 to map the advertiser IDs to the publisher IDs. The third-party agency service 314 uses matching algorithms known in the art to facilitate this process. For example, a match may be determined between a user's advertiser ID and a user's publisher ID based on matching names, date-of-birth, and addresses for each. At a step 326, the third-party agency service 314 assigns a common ID to each matched pair. The common ID may comprise an alphanumeric string that acts to link a user's advertiser ID with the user's publisher ID.

At a step 328, the third-party agency service 314 communicates the common ID(s) 330 to the advertisement publisher service 312. The common ID(s) 330 may be communicated in association with its respective publisher ID. Once received by the advertisement publisher service 312, the advertisement publisher service 312 may store the mapped publisher ID/common ID pair in association with its data store such as the data store 228 of FIG. 2.

At a step 332, the third-party agency service 314 communicates the common ID(s) (now labeled as common IDs 334) to the advertising service 310. The common ID(s) 334 may be communicated in association with its respective advertiser ID. Once received by the advertising service 310, the advertising service 310 may store the mapped advertiser ID/common ID pair in association with its data store such as the data store 222 of FIG. 2. By way of illustrative example, user John Smith may have an advertiser ID comprising yyy1 and a publisher ID comprising xxx1. A common ID comprising zzz1 is assigned to the user John Smith by the third-party agency service 314. The same common ID, zzz1, is communicated to both the advertisement publisher service 312 and the advertiser service 310.

At a step 336, a request for online behavior data 338 is communicated directly from the advertiser service 310 to the advertisement publisher service 312. The request 338 includes common IDs for the consumer buying segment(s) that is the subject of the request 338. The request 338 may be a general request for online behavior data for the segment(s), or the request 338 may indicate specific types of online behavior data of interest to the advertising service 310.

At a step 340, the advertisement publisher service 312 maps each received common ID to its counterpart publisher ID, and utilizes the publisher IDs to access the online behavior data for this group of users. At a step 342, the advertisement publisher service 312 analyzes the online behavior data for the segment. As mentioned earlier, this analysis may comprise identifying top Web sites visited, active viewing times, identified online interests, user intent, advertisement engagement based on demographic characteristics, frequency of interaction, and the like.

At a step 344, the analyzed online behavior data 346 for the segment and the associated common IDs are communicated from the advertisement publisher service 312 to the advertiser service 310. In addition to the analyzed online behavior data 346, the advertisement publisher service 312 may also communicate only or more action suggestions based on the results of the analysis. This value-added service enables the advertisement publisher with its wealth of knowledge regarding online behavior to make helpful suggestions to the advertiser to help increase user engagement with the advertiser's advertising campaigns.

At a step 348, the advertiser service 310 identifies advertiser IDs associated with the received common IDs and stores the analyzed online behavior data for this group in association with its data store. As seen, the result of this process flow 300 is the exchange of meaningful information between advertisers and advertisement publishers in a manner that prevents the sharing of sensitive and protected user information that is proprietary to both the advertiser and the advertisement publisher. Additionally, the direct interaction between advertisers and advertisement publishers facilitates a more customized approach as compared to the traditional “one-size-fits-all” approach used by current third-party intermediary services.

Turning now to FIG. 4, a flow diagram is depicted of an exemplary method 400 of facilitating the exchange of information between an advertiser and an advertisement publisher in a protected manner using common IDs. At a step 410, a third-party agency service such as the third-party agency service 210 of FIG. 2 receives user data from the advertiser. The user data is associated with one or more users who are identified by their respective advertiser IDs which uniquely identifies each user to the advertiser.

At a step 412, the third-party agency service receives user data from the advertisement publisher. The user data is associated with one or more users who are identified by their respective publisher IDs which uniquely identifies each user to the advertisement publisher. The user data received at the steps 410 and 412 may include user identifying information such as first and last name, date-of-birth, address, gender, and the like.

At a step 414, the third-party agency service utilizes the user data to map each advertiser ID to its respective publisher ID. The mapping may utilize known matching algorithms to match up pieces of user identifying data to arrive at a best guess match between an advertiser ID and a publisher ID. At a step 416, the third-party agency service assigns a common ID to each matched advertiser ID/publisher ID pair. This mapping may be stored in association with a data store such as the data store 212 of FIG. 2.

At a step 418, each user's common ID is communicated to the advertiser and the advertisement publisher. For example, the third-party agency service communicates a user's common ID in association with its advertiser ID to the advertiser. No other information from the advertisement publisher is communicated to the advertiser. For instance, the publisher user data and the publisher ID are not communicated to the advertiser by the third-party agency service. Likewise, the third-party agency service communicates each user's common ID in association with its respective publisher ID to the advertisement publisher. No other information (e.g., advertiser ID or advertiser user data) is communicated to the advertisement publisher by the third-party agency service.

FIG. 5 is a flow diagram of an exemplary method 500 carried out by an advertisement publisher service for facilitating the exchange of information directly between an advertiser and the advertisement publisher in an anonymous manner. At a step 510, the advertisement publisher service, such as the advertisement publisher service 226 of FIG. 2, receives a request from the advertiser for online behavior data associated with a consumer buying segment. Each user in the consumer buying segment is identified solely by his or her respective common ID that has been assigned to the user by a third-party agency service such as outlined in the method 400 of FIG. 4.

For each user in the consumer buying segment, at a step 512, the advertisement publisher service identifies a respective publisher ID. The mapping between common IDs and publisher IDs may be stored in association with a data store such as the data store 228 of FIG. 2.

At a step 514, the advertisement publisher service utilizes the publisher IDs to access online behavior data for the consumer buying segment, and, at a step 516, the advertisement publisher service analyzes the online behavior data for the segment. The data may be analyzed for demographic data, engagement history data, top sites visited, identified user interests, active viewing times, frequency of interaction with one or more Web sites, and the like.

At a step 518, the analyzed online behavior data is communicated by the advertisement publisher service to the advertiser using only the users' common IDs. The advertisement publisher service may also communicate one or more action suggestions based on the results of the analysis; the action suggestions are designed to increase user engagement with advertisements generated by the advertiser.

The method 500 can be extended to more than one consumer buying segment. For example, the advertiser may be interested in comparing the online behavior patterns of consumer buying segments that have different buying patterns. The differences in buying patterns are known only to the advertiser; the only information known to the advertisement publisher is the common IDs associated with each of the consumer buying groups. As seen, the use of common IDs ensures that the advertiser does not have to disclose any proprietary information in order to gain access to in-depth online behavior data and action suggestions.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-storage media having computer-executable instructions embodied thereon that, when executed by one or more computing devices, perform a method of facilitating the exchange of information between an advertiser and an advertisement publisher in a protected manner using common identifiers (ID), the method comprising:
at a third-party agency service:
receiving one or more sets of user data from an advertiser, each set of the one or more sets of user data being associated with a user having an advertising ID;
receiving one or more sets of user data from an advertisement publisher, each set of the one or more sets of user data being associated with a user having a publisher ID;
mapping at least one advertising ID to at least one publisher ID, the at least one advertising ID and the at least one publisher ID being associated with a first user;
assigning a common ID to the first user; and
communicating the common ID associated with the first user to the advertiser and to the advertisement publisher.

2. The media of claim 1, wherein the advertising ID uniquely identifies a user to the advertiser.

3. The media of claim 1, wherein the publisher ID uniquely identifies a user to the advertisement publisher.

4. The media of claim 1, wherein mapping the at least one advertising ID to the at least one publisher ID comprises applying a matching algorithm to the one or more sets of user data received from the advertiser and the one or more sets of user data received from the advertisement publisher to identify the first user.

5. The media of claim 1, wherein communicating the common ID associated with the first user to the advertiser and to the to the advertisement publisher comprises:
communicating the common ID and not the publisher ID to the advertiser; and
communicating the common ID and not the advertiser ID to the advertisement publisher.

6. The media of claim 1, wherein the common ID associated with the first user is communicated to the advertiser in association with the first user's advertiser ID, and wherein the common ID associated with the first user is communicated to the advertisement publisher in association with the first user's publisher ID.

7. A computerized method carried out by an advertisement publisher service having at least one processor for facilitating the exchange of information between an advertiser and the advertisement publisher in an anonymous manner, the method comprising:
receiving a request from the advertiser for online behavior data associated with a first set of users, each user in the first set of users identified only by the each user's respective common identifier (ID);
for the each user in the first set of users, identifying a publisher ID associated with the each user's respective common ID;
using the publisher IDs, accessing online behavior data for the first set of users;
analyzing, using the at least one processor, the online behavior data for the first set of users; and
communicating the analyzed online behavior data for the first set of users to the advertiser using only the each user's respective common ID.

8. The method of claim 7, wherein the each user's respective common ID is assigned by a third-party agency service.

9. The method of claim 7, wherein analyzing the online behavior data for the first set of users comprises one or more of analyzing demographic information, Web sites visited, active viewing times, content categories associated with the first set of users, search queries and selected search results, or determined interests for the first set of users.

10. The method of claim 7, further comprising communicating one or more action suggestions to the advertiser based on the analyzed online behavior data for the first set of users.

11. The method of claim 7, further comprising:
receiving a request from the advertiser for a comparison of online behavior data for the first set of users and a second set of users, each user in the second set of users identified only by the each user's respective common ID;
for the each user in the second set of users, identifying a publisher ID associated with the each user's respective common ID;
using the publisher IDs, accessing online behavior data for the second set of users;
analyzing the online behavior data for the second set of users;
comparing the analyzed online behavior data for the first set of users with the analyzed online behavior data for the second set of users; and
communicating the comparison of the analyzed online behavior data for the first set of users and the second set of users to the advertiser using only the each user's respective common ID.

12. The method of claim 11, further comprising communicating one or more action suggestions to the advertiser based on the comparison of the analyzed online behavior data for the first set of users and the second set of users.

13. The method of claim 11, wherein the first set of users and the second set of users have consumer buying patterns known only to the advertiser.

14. The method of claim 13, wherein the first set of users and the second set of users have different consumer buying patterns.

15. The method of claim 7, wherein protected user data known to the advertiser is not communicated to the advertisement publisher.

16. The method of claim 7, wherein protected user data known to the advertisement publisher is not communicated to the advertiser.

17. A system for facilitating the anonymous exchange of information between an advertiser and an advertisement publisher, the system comprising:
a computing device associated with a third-party agency service having one or more processors and one or more computer-storage media; and
a data store coupled with the third-party agency service,
wherein the third-party agency service:
receives sets of user data from the advertiser, each set of user data being associated with a user having an advertising identifier (ID);
receives sets of user data from the advertisement publisher, each set of user data being associated with a user having a publisher ID;
maps each advertising ID to its corresponding publisher ID using the sets of user data from the advertiser and the sets of user data from the advertisement publisher, the each advertiser ID and the each corresponding publisher ID being associated with a same user;
assigns a common ID to each mapped pair; and
communicates the common IDs to the advertiser and the advertisement publisher.

18. The system of claim 17, wherein the sets of user data received from the advertiser and the sets of user data received from the advertisement publisher comprise at least a user name.

19. The system of claim 17, wherein the sets of user data received from the advertiser are not communicated to the advertisement publisher.

20. The system of claim 17, wherein the sets of user data received from the advertisement publisher are not communicated to the advertiser.
